(19) United States
(12) Patent Application Publication
(10) Pub. No.: US 2026/0371109 A1
(43) Pub. Date: Nov. 19, 2026

(54) DYNAMIC MANAGEMENT OF TRACKING AREAS AND REGISTRATION AREAS IN NETWORKS

(71) Applicant: AT&T Intellectual Property I, L.P., Atlanta, GA (US)

(72) Inventors: Yuxuan Jiang, Piscataway, NJ (US); Caglar Tunc, Rutherford, NJ (US); Xuan Tuyen Tran, Bridgewater, NJ (US); Yu Zhou, Somerset, NJ (US)

(73) Assignee: AT&T Intellectual Property I, L.P., Atlanta, GA (US)

(21) Appl. No.: 19/210,241

(22) Filed: May 16, 2025

(51) Int. Cl. H04W 24/02; H04W 8/08

(52) U.S. Cl. CPC H04W 24/02; H04W 8/08

(57) ABSTRACT

Aspects of the subject disclosure may include, for example, receiving, at a processing system including a processor, network data including network profile data, UE profile data, performance indicator measurements, network conditions or a combination thereof; generating, by the processing system, a data structure representing base stations, handover events, and coverage overlaps; determining, by the processing system, TA segmentation boundaries for the data structure; determining, by the processing system, RA assignments for a UE based on the determining of the TA segmentation boundaries and UE mobility patterns; updating, by the processing system, a registration area database with the RA assignments resulting in updated RA assignments; and transmitting, by the processing system, an update signal to a network management function to synchronize the registration area database with the updated RA assignments. Other embodiments are disclosed.

### FIELD OF THE DISCLOSURE

The subject disclosure relates to dynamic management of tracking areas and registration areas.

### BACKGROUND

Wireless communications represent a rapidly evolving field in which efficient management of network resources is of great importance. In current cellular systems, operators divide their networks into geographically defined segments to facilitate location tracking and paging functions. These segments serve as building blocks that help maintain connectivity, monitor user movements, and support timely signal delivery. The organization of mobile network systems in this manner is important to the overall performance and reliability of the network, ensuring that users can be promptly located and connected across diverse operational environments.

Efficient management of network segments plays a role in achieving high-quality service in wireless networks. Operators aim to optimize resource utilization while minimizing delays associated with user connection processes. By defining geographic areas for tracking, networks can reduce the time required to establish communications and can more effectively balance control messaging with data traffic demands. This focus on operational efficiency is driven by the goal of ensuring that users experience seamless connectivity even as network conditions fluctuate with varying levels of traffic intensity and mobility.

Many conventional solutions employ fixed segmentation parameters that are predetermined and static in nature. Such approaches may perform satisfactorily under steady conditions but can struggle when user densities and mobility patterns change abruptly. The inability to adapt segmentation boundaries to real-time network conditions may lead to inefficient use of signaling capacity, increased delays during connection establishment, and suboptimal allocation of network resources. These challenges underscore the limitations of static segmentation strategies and highlight the difficulties faced in an ever-changing network environment.

A particular challenge can be the balance between segmentation granularity and system overhead. When segmentation is too fine, the increased computational and storage demands can burden the network. Conversely, overly-coarse segmentation risks expanding the paging region and diminishing the effectiveness of location management. In current systems, operators may find it increasingly difficult to meet performance targets and maintain efficient network operations amidst fluctuating demand.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIGS. 2C-F are block diagrams illustrating example, non-limiting embodiments of TA/RA management platforms functioning within the communication network of FIG. 1 in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for obtaining, generating, and/or maintaining data (e.g., network profile data, user equipment (UE) profile data, performance indicator measurements, network conditions, etc.) to facilitate efficient management of tracking areas (TAs) and registration areas (RAs). This can be done in a number of different ways including through use of a particular data structure, such as by constructing a network graph (e.g., nodes represent base stations and edges represent handover events or coverage overlaps). Various data structure techniques can be applied such as assigning or otherwise utilizing weights that are assigned based on UE density and/or mobility parameters. The data structure allows for various analyses to obtain various information for network management such as determining TA segmentation boundaries and/or determining RA assignments for a UE (e.g., based on the TA segmentation boundaries and real-time UE mobility patterns). The data can be maintained utilizing various techniques including updating a registration area database with RA assignments. Other embodiments are described in the subject disclosure.

In one or more embodiments, the system and methodology can provide a platform for dynamic joint improvement or optimization of TAs and RAs within communications networks such as 5G, 6G or NG, and in some embodiments can leverage Open Radio Access Network (O-RAN) architecture. Unlike conventional methods that may independently and statically manage TAs and RAs, in one or more embodiments a coordinated and dynamic method can be implemented that adapts to real-world scenarios with changing conditions including UE mobility and usage patterns. By integrating optimization or improvement techniques, including machine learning, artificial intelligence and/or graph segmentation algorithms, in one or more embodiments the system and methodology can consider various impact factors such as UE density, mobility patterns, and/or network capacities. This results in improved performance metrics, such as reduced RRC connection delays and optimized signaling load, while maintaining scalability, and interoperability. In one embodiment, a modular design can be provided that facilitates future enhancements and integration, including with new third-party implementations, making this a forward-looking implementation in an evolving landscape of wireless network infrastructure.

In one or more embodiments, a dynamic joint optimization or improvement of TAs and RAs is provided having a decision pipeline based on O-RAN architecture. This enables coordinating decisions of TAs and RAs to bring enhanced performance and improved efficiency in a network. For example, a dynamic optimization or improvement can be provided in both TA segmentation and RA construction which can accommodate real-world scenarios, where UEs' mobility and usage patterns change over time.

In one or more embodiments, Artificial Intelligence (AI) which can include Machine Learning (ML) can be utilized alone or in conjunction with other techniques, including analytical techniques such as graph segmentation algorithms for TA segmentation and fuzzy clustering for RA construction. In one or more embodiments, the system and methodology enable scalability and interoperability to incorporate new elements and technological developments as they emerge in the future and which can allow for integrating implementations from different providers/vendors.

One or more aspects of the subject disclosure include a method comprising receiving, at a processing system including a processor, network data including network profile data, UE profile data, performance indicator measurements, network conditions or a combination thereof; generating, by the processing system, a data structure representing base stations, handover events, and coverage overlaps; determining, by the processing system, TA segmentation boundaries for the data structure; determining, by the processing system, RA assignments for a UE based on the determining of the TA segmentation boundaries and UE mobility patterns; updating, by the processing system, a registration area database with the RA assignments resulting in updated RA assignments; and transmitting, by the processing system, an update signal to a network management function for synchronizing the network management function with the updated RA assignments

One or more aspects of the subject disclosure include a device comprising a processing system including a processor; and a memory that stores executable instructions that, when executed by the processing system, facilitate performance of operations. The operations can include receiving network data including network profile data, UE profile data, performance indicator measurements, and network conditions; constructing a network graph in which nodes represent base stations and edges represent handover events or coverage overlaps with weights assigned based on UE density and mobility parameters; applying an analysis process to the network graph to determine TA segmentation boundaries, wherein the TA segmentation is performed on a first time scale selected to accommodate substantial network changes; determining RA assignments for a UE based on the TA segmentation boundaries and real-time UE mobility patterns; and updating a registration area database with the RA assignments via an adaptive update module performed on a second time scale that is smaller than the first time scale resulting in updated RA assignments.

One or more aspects of the subject disclosure include a non-transitory machine-readable medium, comprising executable instructions that, when executed by a processing system including a processor, facilitate performance of operations. The operations can include receiving network data including network profile data, UE profile data, performance indicator measurements, network conditions or a combination thereof; generating a data structure representing base stations, handover events, and coverage overlaps, wherein the generating the data structure comprises generating a network graph in which nodes represent the base stations and edges represent the handover events or the coverage overlaps; determining TA segmentation boundaries for the network graph; determining RA assignments for a UE based on the determining of the TA segmentation boundaries and UE mobility patterns; and updating a registration area database with the RA assignments resulting in updated RA assignments.

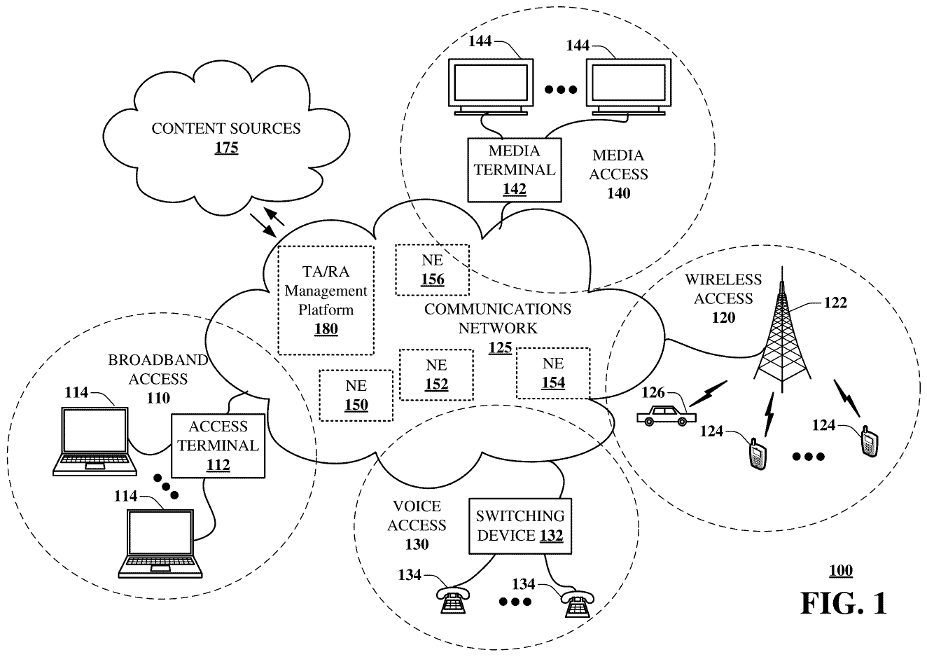

Referring now to FIG. 1, a block diagram is shown illustrating an example, non-limiting embodiment of a system 100 in accordance with various aspects described herein. For example, system 100 through use of TA/RA management platform 180 can facilitate in whole or in part obtaining (e.g., receiving, polling, generating, etc.) network data including network profile data, UE profile data, performance indicator measurements, network conditions, and/or other information that enables making RA and TA determinations. A data structure can be generated or otherwise maintained representing various components, information and events which are pertinent or otherwise useful in making RA and TA determinations, such as base stations, handover events, and coverage overlaps. In one embodiment, the data structure can be a network graph in which nodes represent the base stations and edges represent the handover events or the coverage overlaps. TA segmentation boundaries can be determined for the data structure and RA assignments can be determined for a UE based on the determining of the TA segmentation boundaries and UE mobility patterns. A registration area database can be updated with the RA assignments resulting in updated RA assignments.

Platform 180 makes use of TAs that are each a geographic region within a wireless network (e.g., defined by the network operator) which includes a collection of cells and is used to manage the location tracking of UEs such as when they are in idle mode. In the context of mobile networks, a TA generally serves as a larger geographic area than a single cell.

Platform 180 also makes use of RAs, where each RA can be a group of TAs associated with a UE. An RA can play an important role in tracking the location of UEs and managing their connections. The RA can define the range within which paging messages are broadcasted to locate a UE who is not actively engaged in a communication session, such as when it is in the RRC_IDLE mode. When a UE moves from one RA to another, the UE sends an RA update to the network, allowing the network to keep track of the user's location for efficient paging and connection management. This mechanism helps reduce the signaling load and ensures timely delivery of services to the UE. In one or more embodiments, platform 180 allows for RAs to be customized based on the user's mobility patterns and data transfer demands, while TAs may or may not be customizable. This customization allows the network to optimize or improve paging and connection management by minimizing RA updates, especially for fast-moving devices like vehicles. The RA is typically larger than a TA, which can be acceptable in 5G, 6G and NG networks due to the presence of IoT devices with low data transfer demands. The dynamic update capability of RAs allows changes based on user behavior and network conditions, such as expanding the RA during commuting hours and contracting it when the user is static at home. This adaptability provided via platform 180 helps reduce signaling load and improve network efficiency by aligning the RA with real-time user mobility and network conditions.

One or more of the exemplary embodiments of platform 180 manages TAs and RAs in a coordinated fashion by employing a dynamic joint optimization or improvement approach within an O-RAN architecture that addresses changing UE mobility and usage patterns. For example, platform 180 can conduct dynamic improvement or optimization of both TA segmentation and RA construction by continuously monitoring and adjusting the boundaries of TAs and the configuration of RAs based on real-time network conditions, user mobility patterns, and/or data transfer demands.

Platform 180 can leverage various techniques, including optimization techniques, such as AI, ML, and/or graph segmentation algorithms. These techniques can allow the platform 180 to systematically consider various impact factors such as UE density, mobility patterns, and network capacities. In one embodiment, platform 180 can model the network using graph theory, where nodes represent base stations and edges represent handovers or coverage overlaps such that the graph-based model helps in understanding the network topology and making informed decisions about TA segmentation and RA mapping.

In one embodiment, platform 180 can employ a multi-time-scale (e.g., two-time-scale) optimization or improvement pipeline. For example, a dynamic TA segmentation module can operate on a larger time scale (e.g., day/half-day level) to adapt to major changes in the network, while an adaptive RA database update module can operate on a smaller time scale (e.g., hour level) to respond to more recent changes. Other times scales, including changing time scales and adjustable time scales (e.g., manually or automatically) can be applied by platform 180.

In one embodiment, platform 180 can use Key Performance Indicator (KPI) measurements and operational insights to evaluate current decisions and improve future ones. The KPIs can be of various types including availability, throughput, latency, error rate, and jitter. These metrics help assess the reliability, speed, and overall quality of network communication. For instance, this feedback loop can attempt to ensure that the TA and RA configurations are continuously optimized or improved for current network conditions.

In one embodiment, platform 180 can be provided with a modular design which allows for the inclusion of additional factors and the integration of implementations from different providers/vendors, enhancing flexibility and efficiency in deployment.

By coordinating the management of TAs and RAs in this manner, the platform 180 aims to reduce RRC connection delays, optimize signaling loads, and improve overall network performance while maintaining scalability and interoperability.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

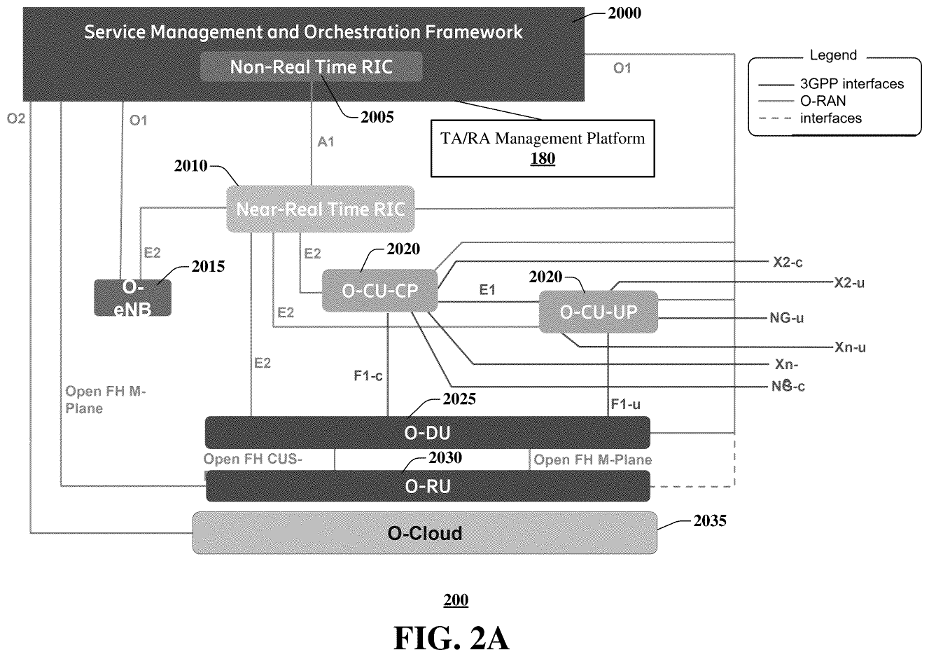

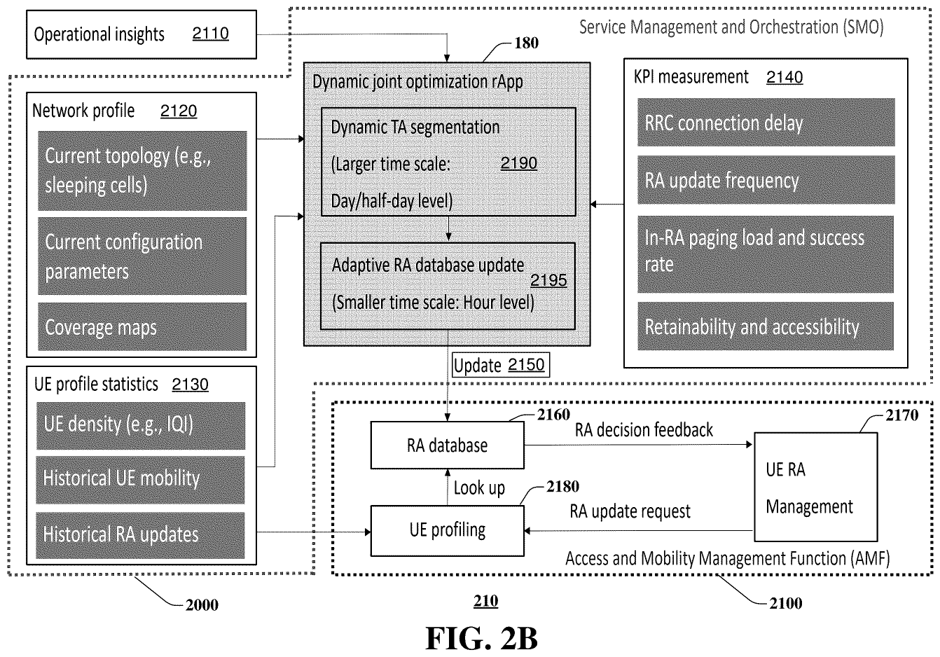

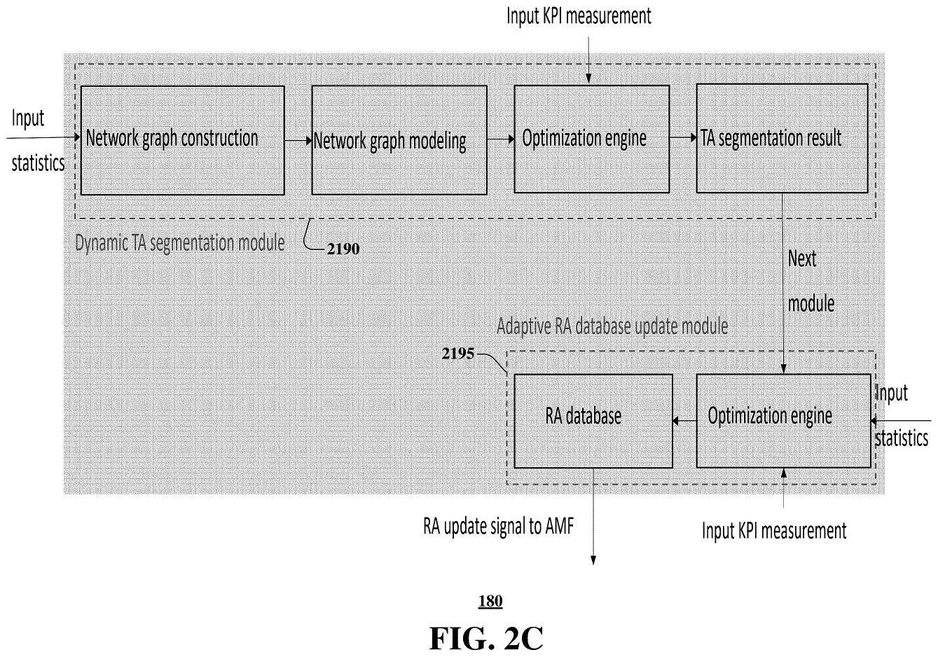

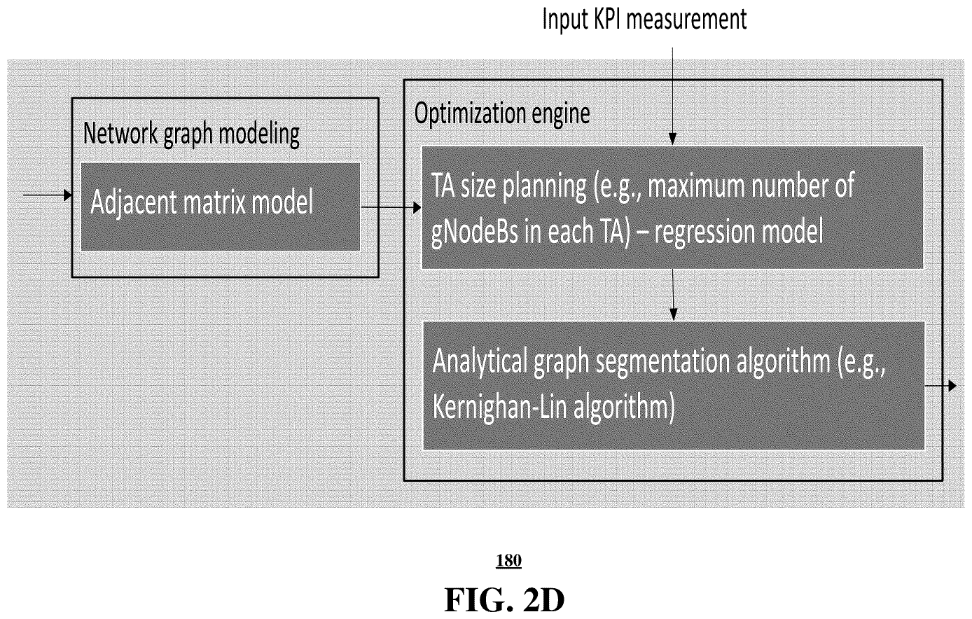

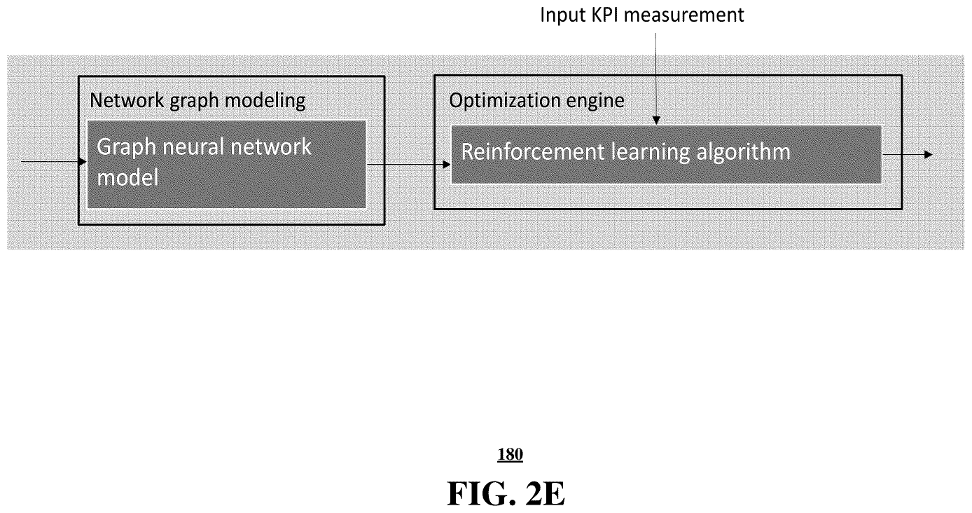

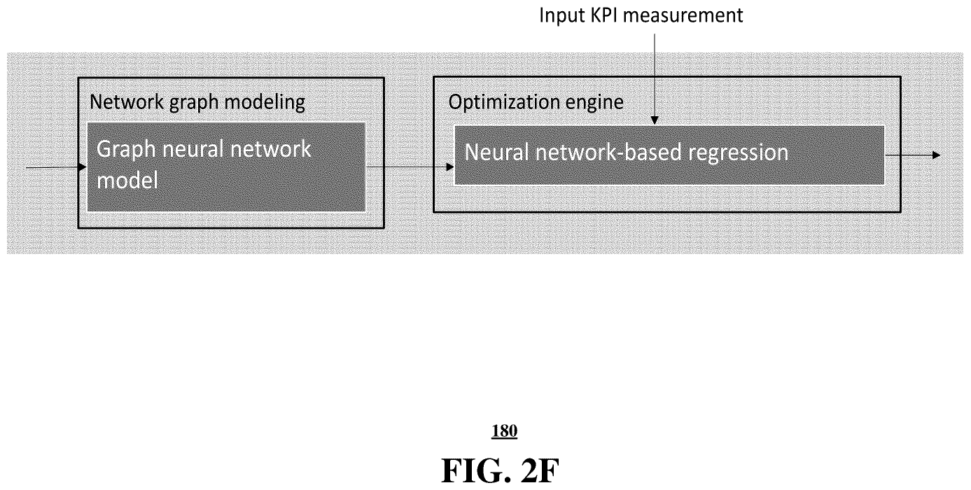

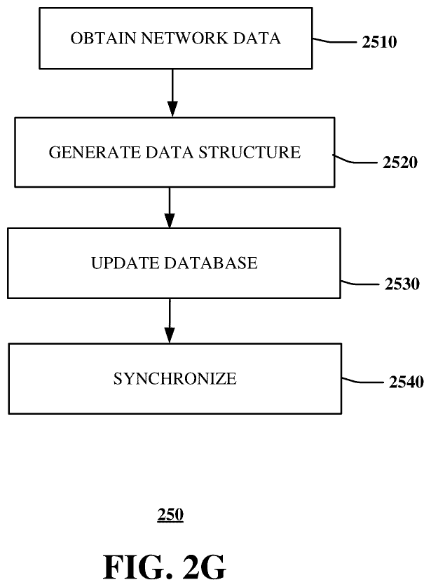

FIG. 2A is a block diagram illustrating an example, non-limiting embodiment of a system 200 functioning within the communication network of FIG. 1 in accordance with various aspects described herein. System 200 is illustrated as an O-RAN communication system, however, features, components and/or functionality of the embodiments described herein can be utilized in other systems which may or may not be O-RAN, including other types of 5G, 6G or NG networks.

The O-RAN architecture of system 200 can promote openness and standardization to transform traditional proprietary RANs to the next-generation RAN, including interaction through standardized interfaces. The Service Management and Orchestration (SMO) framework 2000 is a high-level entity, which plays an important role to monitor, configure, improve and/or optimize the network with the integration and coordination of a series of components with different functionalities. Through the underlying interfaces with the components in the network infrastructure, such as the network core and cell sites, the SMO framework 2000 can collect and store massive amounts of network data, and conduct complex data-driven control tasks over the network.

The non-real-time RAN intelligent controller (non-RT RIC) 2005 is an important component in the SMO framework 2000 which enables deployment of data-driven complex techniques to provide non-real-time/longer-term (e.g., near-real-time can be in the level of milliseconds) optimization, improvement and planning for the RAN.

Non-RT RIC 2005 can utilize rApps (RAN applications) which are software applications, and which can be developed by not only the network operator, but also third parties through standardized interfaces with the non-RT RIC, in order to provide the data-driven dynamic network optimization, improvement and planning. System 200 illustrates that the SMO framework 2000 can obtain or collect network data, including network profile data, UE profile data, and/or performance indicator measurements, which can be important inputs for an improvement or optimization process for TA and RA management. The SMO framework 2000 can interact with various other components, such as through standardized interfaces, ensuring seamless data flow and coordination.

The non-RT RIC 2005 can enable deployment of data-driven techniques for long-term optimization, improvement and planning of the RAN by supporting construction of a data structure for analysis and decision-making (e.g., with respect to TA and RA determination). In one or more embodiments, the data structure can be a network graph, where nodes represent base stations and edges represent handover events or coverage overlaps, and the graph can be used to determine TA segmentation boundaries and RA assignments.

To facilitate the functionality described herein with respect to TA and RA management, system 200 can employ or otherwise utilize the TA/RA management platform 180, which can be similar (e.g., include some or all of the functions and components) to the platform described with respect to FIG. 1. The platform 180 can be an important component that performs the dynamic optimization or improvement of TAs and RAs, including through application of advanced optimization algorithms, such as analytical graph segmentation, regression analysis, machine learning, and fuzzy clustering techniques, to determine TA segmentation boundaries and RA assignments. For instance, these decisions can be based on real-time network conditions, UE mobility patterns, and operational insights.

The near-RT RIC 2010 can facilitate near-real-time adjustments to the network, ensuring that RA assignments are updated dynamically to reflect changes (including recent or real-time changes) in network conditions. In one embodiment, this can align with an adaptive update module (as described herein), which may operate on a smaller time scale relative to TA segmentation updates. Other O-RAN components (including in any number and in any configuration), such as an O-eNB 2015, O-CU-CPs 2020, O-DUs 2025, and O-RUs 2030, can be utilized by the system 200 for providing various communication services and/or which may interact directly and/or indirectly with the TA/RA management platform 180 to implement the optimized/improved TA and RA configurations. In one embodiment, the O-Cloud 2035 can provide computational resources necessary for or otherwise utilized for executing optimization algorithms and maintaining the registration area database. The system 200 depicted in FIG. 2A demonstrates an embodiment of integration of O-RAN architecture components to enable the dynamic joint optimization or improvement of TAs and RAs, which attempts to ensure efficient synchronization of the registration area database with updated RA assignments and facilitates improved network performance and user experience.

FIG. 2B is a block diagram illustrating an example, non-limiting embodiment of a system 210 functioning within the communication network of FIG. 1 in accordance with various aspects described herein. In one or more embodiments, system 210 can be utilized in conjunction with system 200 of FIG. 2A. As an example, system 210 can operate as part of, or in conjunction with, O-RAN communication techniques and components, however, features, components and/or functionality of the embodiments described herein can be utilized in other systems which may or may not utilize O-RAN including other 5G, 6G or NG networks.

System 210 provides an exemplary system for dynamic joint optimization/improvement of TAs and RAs in a wireless communications network to facilitate the coordinated management of TAs and RAs. The operational insights 2110 can include human-derived information which are used to anticipate changes in network demand and influence TA and RA optimization decisions. The network profile data 2120 can be network-wide metadata, including current topology, configuration parameters, and/or coverage maps, which can be important for constructing network graphs (or other representative data structures) and determining TA segmentation boundaries. The UE profile statistics data 2130 can provide fine-grained data about UEs, such as UE density, historical mobility patterns, and/or historical RA updates, which can be used to refine RA assignments and optimize/improve TA segmentation boundaries based on real-time and historical network conditions.

The KPI measurement data 2140 can provide feedback on key performance indicators, such as RRC connection delay, RA update frequency, paging load, and/or success rates, which can be used to evaluate current TA and RA configurations and improve future optimization decisions. The RA database 2160 can store multiple candidate RAs and their corresponding UE characteristics. As an example, it can be regularly updated by the Adaptive RA Database Update Module 2195 to reflect changes in network conditions and/or user behavior. The UE profiling data 2180 can profile individual UEs based on historical statistics and real-time data, which can be used to match UEs to appropriate RA assignments from the RA database. The UE RA management function 2170 of the Access and Mobility Management Function (AMF) 2100 can be responsible for managing RA assignments and synchronizing the RA database 2160 with updated RA configurations. The AMF 2100 can receive update signals from the rApp (e.g., of platform 180) to maintain the RA database in synchronization or otherwise aligned with the latest RA assignments. By leveraging real-time data, historical insights, and advanced optimization techniques, the system 210 dynamically manages TAs and RAs to improve network performance, reduce signaling load, and enhance user experience.

In one or more embodiments, system 210 via the platform 180 can implement a multi-time-scale (e.g., two-time-scale) joint TA-RA improvement/optimization pipeline deployed on the O-RAN architecture. For example, the network profile data 2120 can provide network-wide metadata for TA and RA decisions and can be collected, received or otherwise obtained by the SMO framework 2000 under the O-RAN architecture. The UE profile statistical data 2130 can provide fine-grained UE-level data used for TA and RA decisions and which can also be collected, received or otherwise obtained by the SMO framework 2000.

The KPI measurement data 2140 can provide performance feedback of the TA and RA decisions collected by the SMO framework 2000. The measurements can be used by the rApp to evaluate current decisions and improve future decisions, including through use of AI modeling.

The operational insights 2110 can include or encompass human-provided/generated information. For example, these insights 2110 can be derived from a number of sources such as empirical knowledge of RAN engineers, and external sources such as prior major event notices and weather updates, which the TA/RA decisions can accommodate accordingly.

In one or more embodiments, platform 180 can execute a dynamic joint TA-RA optimization/improvement rApp which can include various modules or portions (e.g., two): a dynamic TA segmentation module 2190 and an adaptive RA database update module 2195. It should be understood that while platform 180 is described as having modules 2190, these modules can be provided in various forms and configurations including via centralized and/or distributed functionality, which can include implementing one, some or all of the functions via cloud or virtual computing. The modules 2190, 2195 can be independent software functionality and/or hardware and can be integrated software functionality and/or hardware.

The dynamic TA segmentation module 2190 can take in the network profile data 2120, UE profile statistical data 2130, KPI measurements 2140, and operational insights 2110 to construct a data structure, such as a graph, that abstracts the features of the network. As an example, the number of hand-overs and the overlaps of the coverage between neighboring cells can be used to quantify the cell correlation and constructed as the weights on the edges of the graph. After constructing the graphical representation of the network (or other data structure), the next step can be to convert it to a specific type of model, such as a graph mathematical model, and then input the model to an optimization engine to make TA segmentation decisions.

Implementation for network graph modeling and optimization engine utilization can be done in a number of different ways including as an adjacent matrix (see FIGS. 2D-2F). Module 2190 can conduct TA segmentation updates in a large time scale (e.g., a day/half-day time frame) to adapt to major changes in the network (e.g., daytime vs nighttime, weekday vs weekend, etc.). In one embodiment, once the TA segmentation changes, all the corresponding RAs can be updated as well. In one embodiment, to avoid massive messaging overhead of simultaneous RA updates, TA segmentation can be updated during off-peak hours, such as early in the morning or late at night.

The adaptive RA database update module 2195 takes in or otherwise obtains the network profile data 2120, UE profile statistical data 2130, KPI measurements 2140, and operational insights 2110, together with the TA segmentation decisions made from the previous module 2190. Through an optimization engine, module 2195 generates (or adjusts) the latest version of the RA database (e.g., local version or portion thereof), and sends an update signal to the AMF 2100 to synchronize it with the RA database 2160 maintained by the AMF. The RA database 2160 contains multiple candidate RAs and their corresponding UE characteristics.

This module 2195 can conduct RA database updates in a smaller time scale to adapt to more recent changes in the network (e.g., peak hours in the morning, a major event). In one or more embodiments, the time scale or frequency of updating can be adjustable and/or dynamic, including manually or automatically changing the frequency of updates based on network conditions, such as generating a non-uniform schedule for updates which accommodates a sporting event in a particular area starting and finishing at certain times when it is predicted that there will be drastic network changes at those start and finish times.

The AMF 2100 in the network core can be responsible for UEs' RA management. As an example, the AMF 2100 can maintain an RA database 2160, which is updated regularly by the dynamic joint optimization rApp operating on or in conjunction with platform 180. When an RA update request for a particular UE is submitted from the UE RA management function 2170 of the AMF 2100, this UE can first be profiled (e.g., via UE profiling function 2180) using the UE historical statistics from UE profile statistics 2130. An RA can then be matched from the RA database 2160 and fed back to the UE RA management function 2170.

FIG. 2C is a block diagram illustrating an example, non-limiting embodiment of a TA/RA management platform 180 functioning within the communication network of FIG. 1 in accordance with various aspects described herein. In one or more embodiments, platform 180 can be utilized in conjunction with systems 200 and/or 210 of FIGS. 2A, 2B. As an example, platform 180 can operate as part of, or in conjunction with, O-RAN communication techniques and components, however, features, components and/or functionality of the embodiments described herein can be utilized in other systems which may or may not be O-RAN including other 5G, 6G or NG networks.

Platform 180, via modules 2190, 2195, facilitate dynamic joint optimization or improvement of TAs and RAs by leveraging real-time data, and advanced optimization techniques. In one embodiment, current topology, configuration parameters, and coverage maps (e.g., via network profile data 2120) and UE density, historical mobility patterns, and historical RA updates (e.g., via UE profile statistics 2130) can be obtained for constructing a network graph, where nodes represent base stations and edges represent handover events or coverage overlaps, and where weights are assigned to nodes and edges based on UE density and mobility parameters. This data can be used to refine RA assignments and optimize or improve TA segmentation boundaries. Platform 180, via modules 2190, 2195, can utilize optimization engines that apply techniques such as analytical graph segmentation, regression analysis, machine learning, and fuzzy clustering. In one embodiment, a local RA database or portion thereof can be maintained to store multiple candidate RAs and their corresponding UE characteristics and can be utilized by the Adaptive RA database update module 2195 for keeping the AMF 2100 in sync as to RA assignments that are based on real-time network conditions and user mobility patterns. FIG. 2C demonstrates how the TA/RA management platform 180 integrates data collection and optimization algorithms to dynamically manage TAs and RAs. This system enables efficient synchronization of the registration area database, reduces signaling load, and improves overall network performance.

FIG. 2D is a block diagram illustrating an example, non-limiting embodiment of a portion of TA/RA management platform 180 functioning within the communication network of FIG. 1 in accordance with various aspects described herein. In one or more embodiments, platform 180 can be utilized in conjunction with systems 200 and/or 210 of FIGS. 2A, 2B. As an example, platform 180 can operate as part of, or in conjunction with, O-RAN communication techniques and components, however, features, components and/or functionality of the embodiments described herein can be utilized in other systems which may or may not be O-RAN including other 5G, 6G or NG networks.

In one embodiment, the platform 180 can integrate components that facilitate the collection, processing, and optimization of network data to dynamically manage TAs and RAs such as through a network graph representing the network topology, where nodes correspond to base stations and edges represent handover events or coverage overlaps, and where weights are assigned to nodes and edges based on UE density and mobility parameters. As an example, the graph can be modeled as an adjacent matrix. With the graph model and the KPI feedback, a regression model can first determine the size of each TA. An analytical graph segmentation algorithm (e.g., Kernighan-Lin algorithm) can be applied to partition the graph into disjoint subgraphs, where each subgraph corresponds to a TA, the sum of the edge weights along the boundaries of the subgraphs is minimized (or reduced), and the sum of the node weights in each subgraph does not exceed the size of the corresponding TA. Other techniques can also be applied including use of machine learning approaches (see FIGS. 2E-2F).

FIG. 2E is a block diagram illustrating an example, non-limiting embodiment of a portion of TA/RA management platform 180 functioning within the communication network of FIG. 1 in accordance with various aspects described herein. In one or more embodiments, platform 180 can be utilized in conjunction with systems 200 and/or 210 of FIGS. 2A, 2B. As an example, platform 180 can operate as part of, or in conjunction with, O-RAN communication techniques and components, however, features, components and/or functionality of the embodiments described herein can be utilized in other systems which may or may not be O-RAN including other 5G, 6G or NG networks.

In one embodiment, network graph modeling can be implemented by platform 180 to construct a graph representation of the network, where nodes represent base stations and edges represent handover events or coverage overlaps. In another embodiment, this graph can be enhanced using a graph neural network model, which captures complex interactions within the network topology. For example, weights can be assigned to nodes and edges based on UE density and mobility parameters, ensuring that the graph accurately reflects the network's operational state. In another embodiment, an optimization engine of the platform 180 can apply a reinforcement learning algorithm to adaptively determine TA segmentation boundaries and RA assignments. For instance, reinforcement learning can enable the system to continuously learn and optimize configurations by interacting with the network environment and maximizing or increasing cumulative rewards, such as reduced signaling load and improved connection delays. This dynamic approach can include TA segmentation being performed on a larger time scale to accommodate substantial network changes, while RA assignments are updated on a smaller time scale to reflect more recent changes in network conditions. Platform 180 depicted in FIG. 2E demonstrates how advanced machine learning techniques, such as graph neural networks and reinforcement learning, can be integrated into the optimization process. By leveraging these techniques, the platform 180 dynamically manages TAs and RAs to improve network performance, reduce signaling overhead, and enhance user experience.

FIG. 2F is a block diagram illustrating an example, non-limiting embodiment of a portion of TA/RA management platform 180 functioning within the communication network of FIG. 1 in accordance with various aspects described herein. In one or more embodiments, platform 180 can be utilized in conjunction with systems 200 and/or 210 of FIGS. 2A, 2B. As an example, platform 180 can operate as part of, or in conjunction with, O-RAN communication techniques and components, however, features, components and/or functionality of the embodiments described herein can be utilized in other systems which may or may not be O-RAN including other 5G, 6G or NG networks.

Platform 180 can apply network graph modeling to construct a graph representation of the network, where nodes represent base stations and edges represent handover events or coverage overlaps. This graph can be enhanced using advanced modeling techniques to capture the relationships and interactions within the network topology, where weights are assigned to nodes and edges based on UE density, mobility parameters, and other relevant factors. An optimization engine of platform 180 can apply sophisticated algorithms to determine TA segmentation boundaries and RA assignments, where these algorithms may include various techniques, such as neural network-based regression, to adaptively optimize or improve configurations by interacting with the network environment including through obtaining or receiving KPI measurement data. The optimization process can include TA segmentation being performed on a larger time scale to accommodate substantial network changes, while RA assignments are updated on a smaller time scale to reflect more recent changes in network conditions.

FIG. 2G depicts an illustrative embodiment of a method 250 in accordance with various aspects described herein. Method 250 provides an exemplary flow diagram for dynamic joint optimization or improvement of managing TAs and RAs in a wireless communications network. At 2510, network data can be obtained which can include receiving the network data from various sources, such as network profile data, UE profile data, performance indicator measurements, operational insights and other information that can facilitate TA and RA decisions. This data may also include historical UE mobility data and external factors such as weather conditions, maintenance events, or major event schedules, which are used to anticipate changes in network demand. The network data can serve as a foundation for constructing a data structure, such as a network graph, at 2520 which represents the network topology, where nodes correspond to base stations and edges represent handover events or coverage overlaps. Weights can be assigned to nodes and edges based on various factors including UE density, mobility parameters, and other relevant factors, and advanced techniques, such as graph neural networks, may be employed to enhance the accuracy of the graph representation.

Using the network graph (or other generated data structure), an optimization algorithm(s) can be applied at 2530, such as analytical graph segmentation, regression analysis, machine learning, reinforcement learning, and/or fuzzy clustering techniques, to determine TA segmentation boundaries. In one embodiment, these boundaries can be updated at a particular time scale that is selected to accommodate substantial network changes, such as daily commuter patterns or major events. Based on the TA segmentation, RA assignments can be dynamically updated in an RA database (e.g., a local RA database maintained by or accessible to the platform 180). In one embodiment, the RA database may also incorporate historical mobility data to predict future patterns and/or optimize RA assignments.

At 2540, an update signal can be transmitted to the network management function, such as the AMF 2100, to synchronize the registration area database with the updated RA assignments, such as via an adaptive update module operating on a smaller time scale to respond to more recent changes in network conditions. In one embodiment, the update signal may include priority levels for RA assignments to enable differentiated handling based on UE service requirements. The steps depicted in FIG. 2G demonstrate the coordinated and dynamic management of TAs and RAs, leveraging real-time data, advanced optimization techniques, and feedback mechanisms to improve network performance and efficiency. In one embodiment, the updated TA and/or RA information can be provided to other devices as well.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The coordinated management of TAs and RAs provided by one or more of the embodiments described herein differ from contemporary systems in several key ways including dynamic management, joint management, optimization techniques, graph theory, time scaling, feedback, and interoperability. Contemporary systems often manage TAs and RAs using static parameters that do not change in response to real-time network conditions. In contrast, method 250 employs a dynamic joint optimization/improvement approach that can in some embodiments continuously or frequently adapt TA and RA configurations based on real-time data, user mobility patterns, and network conditions. This allows for more responsive and efficient management. Traditional systems typically manage TAs and RAs independently, without considering the interdependencies between them. Method 250 coordinates the management of TAs and RAs through a joint optimization/improvement process, ensuring that decisions regarding one area are informed by and aligned with decisions regarding the other. This leads to more holistic and effective network management. Method 250 integrates advanced optimization techniques such as machine learning, artificial intelligence, and/or graph segmentation algorithms. These techniques enable systematically considering a wide range of impact factors, such as UE density and mobility patterns, which are often overlooked in conventional systems. Method 250 can use graph theory to model the network, with nodes representing base stations and edges representing handovers or coverage overlaps. This approach provides a more detailed and accurate representation of the network topology, facilitating better-informed decisions about TA segmentation and RA mapping. Method 150 can employ a multi-time-scale optimization pipeline (e.g. two-time-scale), with different modules operating on different time scales to address both major and minor changes in the network. This contrasts with traditional systems that may not have the capability to adjust at multiple time scales. Method 250 can incorporate a feedback loop using KPI measurements and operational insights to evaluate (e.g., continuously or frequently) and refine TA and RA configurations. This adaptive approach is more sophisticated than the static configurations typically used in contemporary systems.

Method 250 allows for the integration of new elements and technologies, as well as interoperability with different providers/vendors, such as through a modular design in some embodiments. This flexibility is often lacking in traditional systems, which may be more rigid and less adaptable to new developments.

There are several types of machine learning and artificial intelligence techniques that can be employed for managing TAs and RAs in method 250. These techniques can enhance the dynamic optimization/improvement process by providing more sophisticated analysis and decision-making capabilities. For example, supervised learning can be implemented. Techniques such as regression analysis and decision trees can be used to predict optimal TA and RA configurations based on historical data and current network conditions. These models can learn from labeled data to make informed decisions about segmentation and mapping.

As another example, method 250 can implement unsupervised learning. Clustering algorithms, such as k-means or hierarchical clustering, can be used to group UEs based on mobility patterns and data transfer demands. This can help in customizing RAs and optimizing TA segmentation by identifying patterns in the data without predefined labels.

As another example, method 250 can implement reinforcement learning. This approach can be used to continuously or frequently adapt TA and RA configurations by learning from interactions with the network environment. Reinforcement learning algorithms can optimize decision-making by maximizing cumulative rewards, such as reduced signaling load and improved connection delays.

As another example, method 250 can implement deep learning. Neural networks, including convolutional neural networks (CNNs) and recurrent neural networks (RNNs), can be employed to model complex relationships within the network data. These models can capture intricate patterns and dependencies, leading to more accurate predictions and optimizations.

As another example, method 250 can implement graph neural networks. These networks can be particularly useful for modeling the network topology, where nodes represent base stations and edges represent handovers or coverage overlaps. Graph neural networks can leverage the structure of the network to make more informed decisions about TA segmentation and RA mapping.

As another example, method 250 can implement fuzzy logic. Fuzzy clustering algorithms can be used to handle uncertainty and imprecision in the data, allowing for more flexible and adaptive RA construction. This approach can accommodate varying degrees of membership in different clusters, reflecting the dynamic nature of user mobility and network conditions.

By integrating these machine learning and AI techniques, method 250 can achieve more effective and efficient management of TAs and RAs, adapting to real-time changes in the network environment and optimizing performance metrics.

Method 250 can focus on jointly optimizing or improving the TA segmentation and RA construction in communication networks, including 5G, 6G, NG. An accurate optimization decision is non-trivial and can consider various factors, which in this case can include UEs' density and mobility patterns, the radio and network capacities, and service requirements (e.g., delay) in order to optimize network KPIs such as the delay in RRC connection creation, and the signaling load of RA updates and paging messages. Method 250 can avoid an RA construction that does not consider UEs' density and mobility patterns which can result in too frequent RA updates, increasing the signaling load over the network. Method 250 can further avoid radio and network capacities not being accounted for, in which case an RA can be too large to incur an increased broadcasting load for paging messages. Given the fixed signaling capacity over the network, method 250 can also avoid a UE experiencing a higher latency in establishing an RRC connection due to a queueing delay of paging message transmission.

In terms of TA segmentation, method 250 can avoid a TA being too small and fine-grained in that a huge number of TAs can impose severe storage costs and higher computation complexity in RA construction. Further, method 250 can avoid a TA being too large, which loses the flexibility as basic building blocks for RAs. Method 250 can also implement segmenting TAs via the aforementioned factors to create effective and meaningful building blocks for RA construction.

Method 250 accommodates the fact that in modern wireless networks, the aforementioned factors are not static, but changing over time. For example, UEs' density and mobility patterns change due to daily commuter patterns, holidays, and major events. The network capacity changes due to dynamic network configuration (e.g., cell sleep mode, allowed/non-allowed areas). Meanwhile, the introduction of the O-RAN has facilitated or enabled in some instances deploying complex and dynamic management functions onto the network.

In one embodiment, method 250 avoids TAs and RAs being decisioned independently and being based on simplified rules or knowledge/experience in a specific domain which do not provide for improved or optimized performance. These simplified heuristic methods, however, lack a comprehensive consideration of various impact factors and can result in suboptimal performance which fails to handle complex scenarios.

In one embodiment, method 250 can employ functionality that can take into account multiple impact factors and can employ more sophisticated decision schemes, including analytical algorithms and machine learning techniques that result in a more holistic and well-informed decision-making process. Method 250 can provide TA segmentation which changes over time according to the factors and analytics described herein.

Method 250 can employ various data structures to represent base stations, handover events, coverage overlaps or other network/communication information in the context of TA and RA management. These data structures can facilitate the modeling and optimization processes by providing a structured way to capture the relationships and interactions within the network. In one embodiment, method 250 can utilize an adjacency list, which can include a collection of lists used to represent a graph. Each list can correspond to a node (base station) and can contain the nodes that are directly connected to it (e.g., representing handover events or coverage overlaps). This data structure can be efficient for sparse graphs and can be useful for dynamic updates.

In one embodiment, method 250 can utilize an incidence matrix, which is a matrix representation where rows correspond to nodes (e.g., base stations) and columns correspond to edges (e.g., handover events or coverage overlaps). Each entry in the matrix can indicate whether a particular node is incident to a particular edge.

In one embodiment, method 250 can utilize an edge list, which can include a list of all edges in the graph, where each edge is represented as a pair of nodes (e.g., base stations) it connects. This data structure can be simple and can be efficient for certain types of graph algorithms.

In one embodiment, method 250 can utilize a graph database, which can be a specialized database designed to store and query graph-structured data. It can efficiently handle complex queries about the relationships between nodes and edges, making it suitable for large-scale network modeling.

In one embodiment, method 250 can utilize a sparse matrix, which can include a matrix representation that is optimized or improved for storing and processing sparse data, where most of the elements are zero. It can be used to represent the adjacency or incidence matrix of a graph with many nodes but relatively few edges.

In one embodiment, method 250 can utilize a hypergraph, which can include a generalization of a graph where an edge can connect more than two nodes. It can be used to model complex relationships involving multiple base stations and coverage overlaps.

In one embodiment, method 250 can utilize a tensor representation. For example, tensors can be used to represent multi-dimensional data, capturing more complex interactions between base stations, handover events, and coverage overlaps. This can be particularly useful for advanced machine learning models. By utilizing these data structures (alone, in combination, and/or in conjunction with a network graph), the method 250 can effectively model the network topology and facilitate the optimization of TAs and RAs.

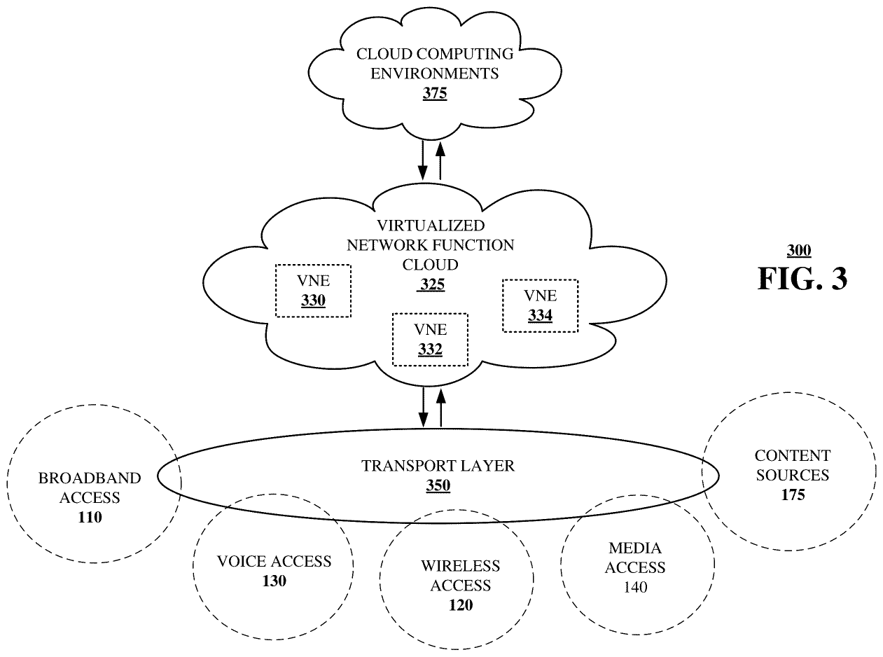

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, functions and methods presented in FIGS. 1, 2A-2G and 3. For example, virtualized communication network 300 can facilitate in whole or in part obtaining (e.g., receiving) network data including network profile data, UE profile data, performance indicator measurements, network conditions, and/or other information that enables making RA and TA determinations. A data structure can be generated or otherwise maintained representing various components, information and events which are pertinent or otherwise useful in making RA and TA determinations, such as base stations, handover events, and coverage overlaps. In one embodiment, the data structure can be a network graph in which nodes represent the base stations and edges represent the handover events or the coverage overlaps. TA segmentation boundaries can be determined for the data structure and RA assignments can be determined for a UE based on the determining of the TA segmentation boundaries and UE mobility patterns. A registration area database can be updated with the RA assignments resulting in updated RA assignments.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

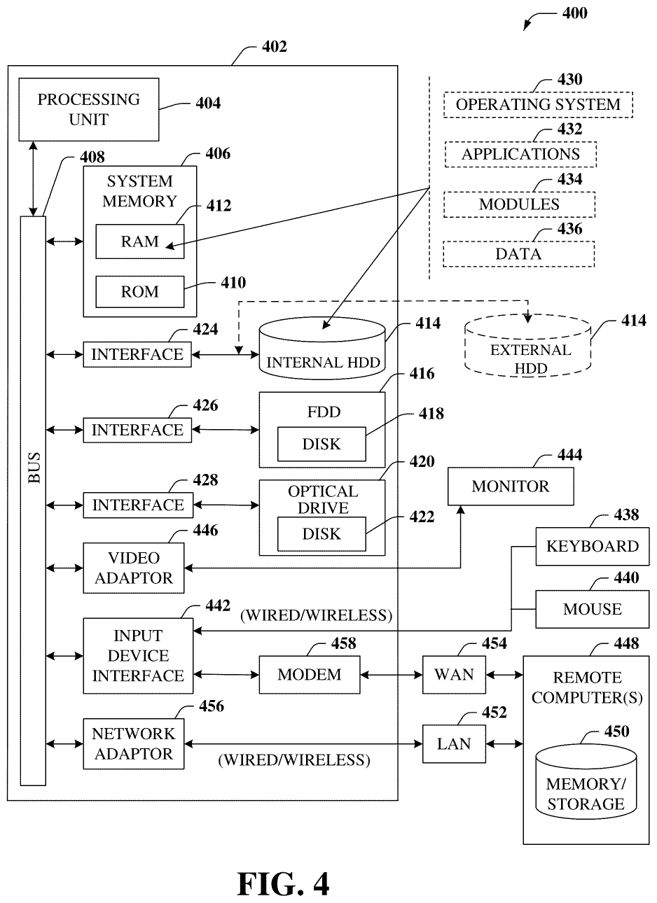

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part obtaining (e.g., receiving) network data including network profile data, UE profile data, performance indicator measurements, network conditions, and/or other information that enables making RA and TA determinations. A data structure can be generated or otherwise maintained representing various components, information and events which are pertinent or otherwise useful in making RA and TA determinations, such as base stations, handover events, and coverage overlaps. In one embodiment, the data structure can be a network graph in which nodes represent the base stations and edges represent the handover events or the coverage overlaps. TA segmentation boundaries can be determined for the data structure and RA assignments can be determined for a UE based on the determining of the TA segmentation boundaries and UE mobility patterns. A registration area database can be updated with the RA assignments resulting in updated RA assignments.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

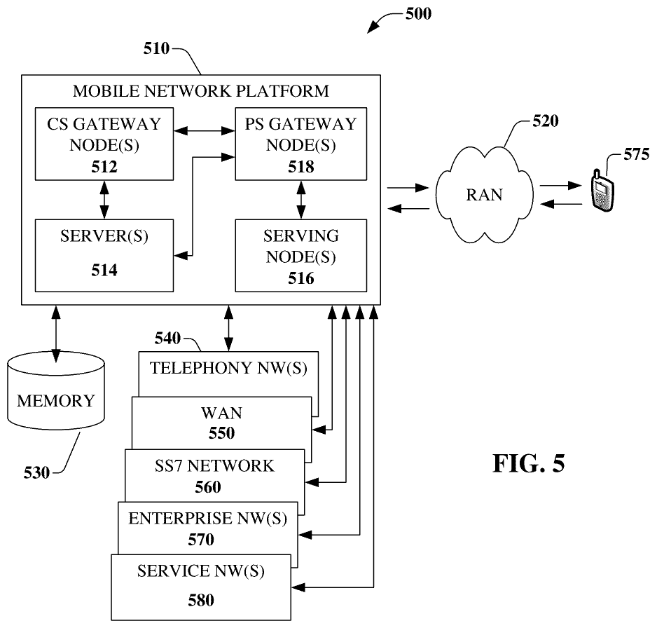

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining (e.g., receiving) network data including network profile data, UE profile data, performance indicator measurements, network conditions, and/or other information that enables making RA and TA determinations. A data structure can be generated or otherwise maintained representing various components, information and events which are pertinent or otherwise useful in making RA and TA determinations, such as base stations, handover events, and coverage overlaps. In one embodiment, the data structure can be a network graph in which nodes represent the base stations and edges represent the handover events or the coverage overlaps. TA segmentation boundaries can be determined for the data structure and RA assignments can be determined for a UE based on the determining of the TA segmentation boundaries and UE mobility patterns. A registration area database can be updated with the RA assignments resulting in updated RA assignments.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

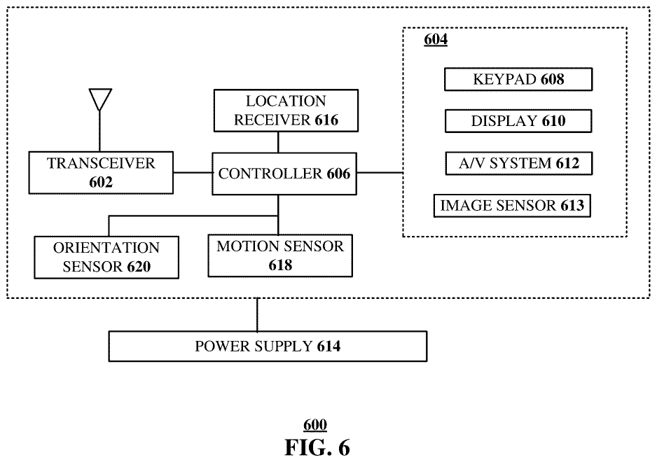

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part obtaining (e.g., receiving) network data including network profile data, UE profile data, performance indicator measurements, network conditions, and/or other information that enables making RA and TA determinations. A data structure can be generated or otherwise maintained representing various components, information and events which are pertinent or otherwise useful in making RA and TA determinations, such as base stations, handover events, and coverage overlaps. In one embodiment, the data structure can be a network graph in which nodes represent the base stations and edges represent the handover events or the coverage overlaps. TA segmentation boundaries can be determined for the data structure and RA assignments can be determined for a UE based on the determining of the TA segmentation boundaries and UE mobility patterns. A registration area database can be updated with the RA assignments resulting in updated RA assignments.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, at a processing system including a processor, network data including network profile data, user equipment (UE) profile data, performance indicator measurements, network conditions or a combination thereof;
generating, by the processing system, a data structure representing base stations, handover events, and coverage overlaps;
determining, by the processing system, Tracking Area (TA) segmentation boundaries for the data structure;
determining, by the processing system, Registration Area (RA) assignments for a UE based on the determining of the TA segmentation boundaries and UE mobility patterns;
updating, by the processing system, a registration area database with the RA assignments resulting in updated RA assignments; and
transmitting, by the processing system, an update signal to a network management function for synchronizing the network management function with the updated RA assignments.

2. The method of claim 1, wherein the network management function maintains a database, wherein the synchronizing of the network management function is based on adjustments to the database according to the updated RA assignments, and wherein the determining the TA segmentation boundaries includes applying at least one of analytical process of analytical graph segmentation, regression analysis, machine learning, or fuzzy clustering techniques.

3. The method of claim 1, wherein the TA segmentation boundaries are determined on a first time scale that is selected to accommodate network changes.

4. The method of claim 3, wherein the updating the registration area database with the RA assignments is via an adaptive update module performed on a second time scale that is smaller than the first time scale.

5. The method of claim 4, wherein the UE mobility patterns are determined in real-time.

6. The method of claim 1, wherein the generating the data structure comprises generating a network graph in which nodes represent the base stations and edges represent the handover events or the coverage overlaps.

7. The method of claim 6, wherein the generating the network graph includes utilizing weights assigned based on UE density and mobility parameters.

8. The method of claim 1, wherein the network data further includes historical UE mobility data, which is used to predict future mobility patterns.

9. The method of claim 1, further comprising employing a reinforcement learning algorithm to adapt TA and RA configurations based on feedback from network performance indicators.

10. The method of claim 1, wherein the update signal transmitted to the network management function includes a priority level enabling differentiated handling based on UE service requirements.

11. The method of claim 1, further comprising applying a graph neural network model to enhance an accuracy of TA segmentation decisions by capturing interactions within a network topology.

12. The method of claim 1, further comprising obtaining weather conditions and event schedules to determine anticipated changes in network demand.

13. A device, comprising:
a processing system including a processor; and
a memory that stores executable instructions that, when executed by the processing system, facilitate performance of operations, the operations comprising:
receiving network data including network profile data, user equipment (UE) profile data, performance indicator measurements, and network conditions;
constructing a network graph in which nodes represent base stations and edges represent handover events or coverage overlaps with weights assigned based on UE density and mobility parameters;
applying an analysis process to the network graph to determine TA segmentation boundaries, wherein the TA segmentation is performed on a first time scale selected to accommodate substantial network changes;
determining RA assignments for a UE based on the TA segmentation boundaries and real-time UE mobility patterns; and
updating a registration area database with the RA assignments via an adaptive update module performed on a second time scale that is smaller than the first time scale resulting in updated RA assignments.

14. The device of claim 13, wherein the operations further comprise:
transmitting an update signal to a network management function to synchronize a database of the network management function with the updated RA assignments.

15. The device of claim 13, wherein the determining the TA segmentation boundaries includes applying at least one analytical process of analytical graph segmentation, regression analysis, machine learning, or fuzzy clustering techniques.

16. The device of claim 13, wherein the network data further includes historical UE mobility data, which is used to predict future mobility patterns.

17. The device of claim 14, wherein the operations include employing a reinforcement learning algorithm to adapt TA and RA configurations based on feedback from network performance indicators.

18. A non-transitory machine-readable medium, comprising executable instructions that, when executed by a processing system including a processor, facilitate performance of operations, the operations comprising:
receiving network data including network profile data, user equipment (UE) profile data, performance indicator measurements, network conditions or a combination thereof;
generating a data structure representing base stations, handover events, and coverage overlaps, wherein the generating the data structure comprises generating a network graph in which nodes represent the base stations and edges represent the handover events or the coverage overlaps;
determining Tracking Area (TA) segmentation boundaries for the network graph;
determining Registration Area (RA) assignments for a UE based on the determining of the TA segmentation boundaries and UE mobility patterns; and
updating a registration area database with the RA assignments resulting in updated RA assignments.

19. The non-transitory machine-readable medium of claim 18, wherein the TA segmentation boundaries are determined on a first time scale selected to accommodate substantial network changes, wherein the updating the registration area database with the RA assignments is via an adaptive update module performed on a second time scale that is smaller than the first time scale, and wherein the operations further comprise:
transmitting, by the processing system, an update signal to a network management function to synchronize a database of the network management function with the updated RA assignments.

20. The non-transitory machine-readable medium of claim 18, wherein the determining the TA segmentation boundaries includes applying at least one analytical process of analytical graph segmentation, regression analysis, machine learning, or fuzzy clustering techniques, and wherein the network data further includes historical UE mobility data, which is used to predict future mobility patterns.
